(19) United States
(12) Patent Application Publication
(10) Pub. No.: US 2023/0024421 A1
(43) Pub. Date: Jan. 26, 2023

(54) STEER-BY-WIRE STEERING APPARATUS

(71) Applicant: MANDO CORPORATION, Gyeonggi-do (KR)

(72) Inventor: Je Hyeon YEON, Gangwon-do (KR)

(21) Appl. No.: 17/788,541

(22) PCT Filed: Jan. 14, 2021
(86) PCT No.: PCT/KR2021/000539

§ 371 Date: Jun. 23, 2022

(30) Foreign Application Priority Data
Jan. 15, 2020 (KR) 10-2020-0005212

(51) Int. Cl. B62D 5/00; B62D 15/02

(52) U.S. Cl. CPC B62D 5/006; B62D 15/0215

(57) ABSTRACT

According to embodiments of the present invention, the maximum rotation angle of a steering wheel can be easily changed, the steering feel provided to a driver can be enhanced by improved noise performance, and the durability of components can be improved.

### TECHNICAL FIELD

The present embodiments relate to a steer-by-wire steering device and, more specifically, to a steer-by-wire steering device that may easily change the maximum rotational angle of the steering wheel, mitigate noise to provide the driver with a better steering sensation, and provide enhanced component durability.

### BACKGROUND ART

A steer-by-wire steering device is a kind of electromotive steering device that steers the vehicle using electric power without any mechanical connection, such as a steering column or universal joint, between the steering wheel and the front wheel steering device.

Such a steer-by-wire steering device lacks a mechanical connection between the steering shaft and the wheel and thus requires a device for restraining further rotation of the steering wheel if the steering wheel rotates up to a predetermined rotational angle.

Conventionally, the maximum rotational angle of the steering wheel is restrained by a nut that is coupled with the steering shaft via a screw and axially slides when the steering shaft rotates and stoppers provided on two opposite sides of the nut. However, after the nut and stopper are coupled, it is hard to change the maximum rotational angle of the steering wheel, and the contact surface between the nut and the stopper may be deformed or the coupling portion of the stopper may be damaged as endurance proceeds. Further, when the steering wheel reaches the maximum rotational angle, the driver's steering feeling may be degraded due to the impact sound between the nut and the stopper.

### DETAILED DESCRIPTION OF THE INVENTION

### Technical Problem

The present embodiments have been conceived in the foregoing background and relate to a steer-by-wire steering device that may easily change the maximum rotational angle of the steering wheel, mitigate noise to provide the driver with a better steering sensation, and provide enhanced component durability.

### Technical Solution

According to the present embodiments, there may be provided a steer-by-wire steering device comprising a steering shaft including a wing portion radially extruding from an outer circumferential surface thereof, a housing having a receiving space for receiving the wing portion, coupled to the steering shaft, and having a rheological fluid in the receiving space, and an electronic control unit controlling a viscosity of the rheological fluid to, if the steering angle of the steering shaft reaches a first rotational angle, solidify the rheological fluid to restrain rotation of the steering shaft.

### Advantageous Effects

According to the present embodiments, it is possible to easily change the maximum rotational angle of the steering wheel, mitigate noise to provide the driver with a better steering sensation, and provide enhanced component durability.

### BRIEF DESCRIPTION OF THE DRAWINGS

FIG. 1 is a cross-sectional view illustrating a steer-by-wire steering device according to the present embodiments;

FIG. 2 is a view illustrating an operation state of a rheological fluid;

FIGS. 3 to 6 are graphs illustrating a control scheme of a steer-by-wire steering device according to the present embodiments; and

FIGS. 7 and 8 are flowcharts illustrating a control scheme according to a driving mode of a steer-by-wire steering device according to the present embodiments.

### MODE FOR CARRYING OUT THE INVENTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

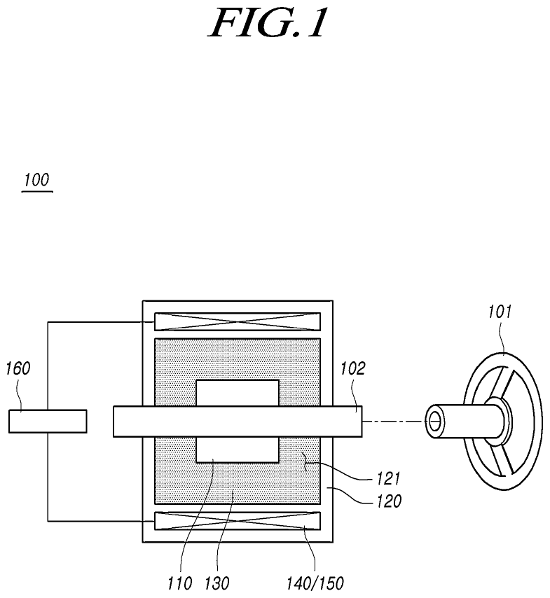

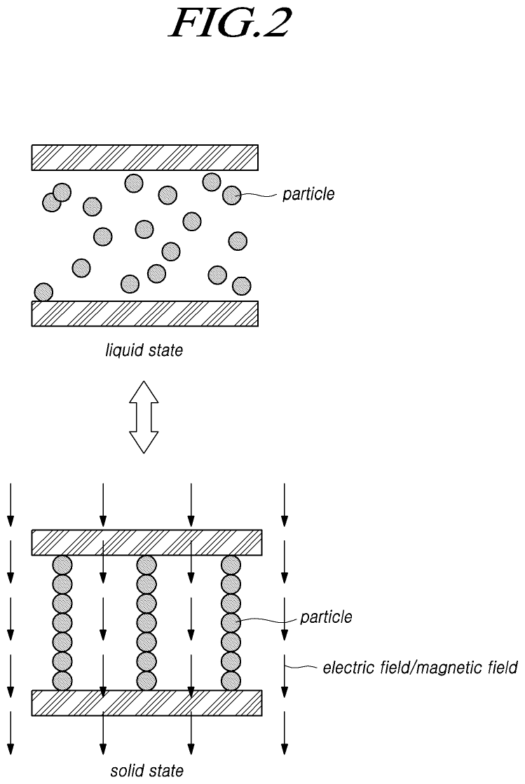

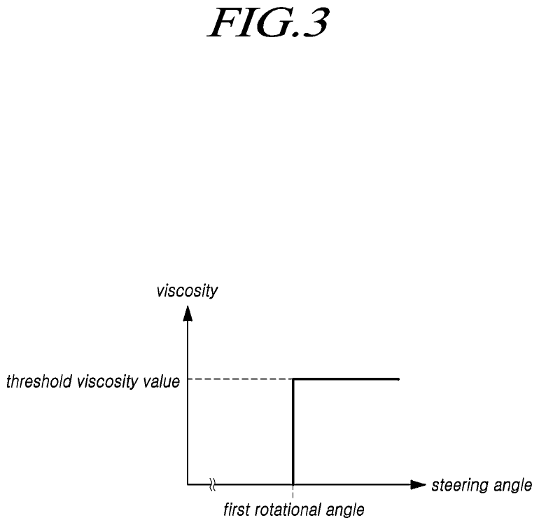

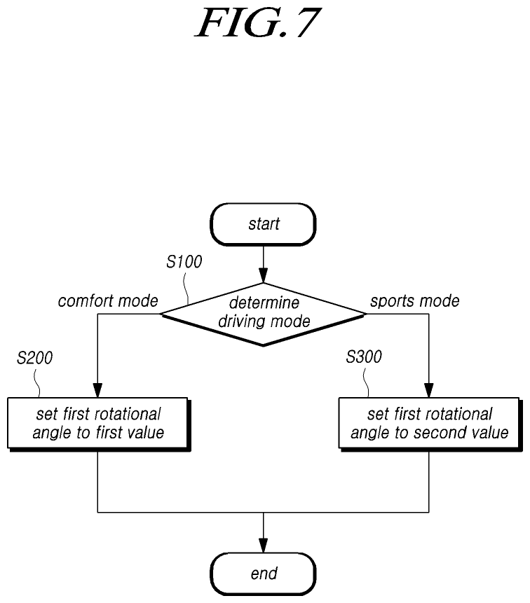

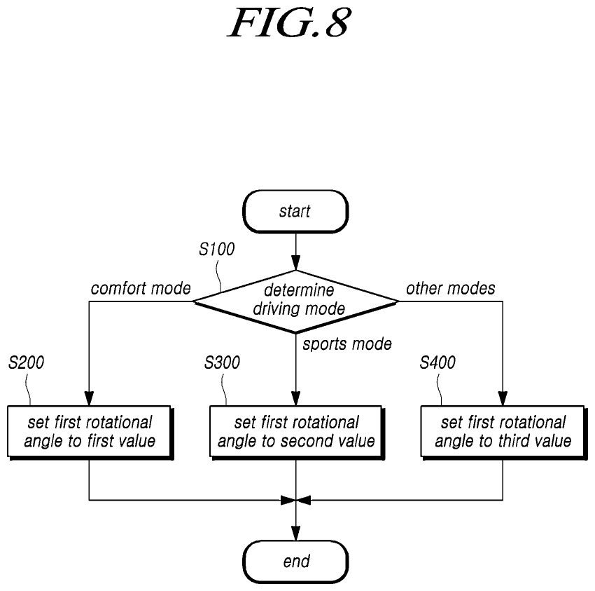

FIG. 1 is a cross-sectional view illustrating a steer-by-wire steering device according to the present embodiments. FIG. 2 is a view illustrating an operation state of a rheological fluid. FIGS. 3 to 6 are graphs illustrating a control scheme of a steer-by-wire steering device according to the present embodiments. FIGS. 7 and 8 are flowcharts illustrating a control scheme according to a driving mode of a steer-by-wire steering device according to the present embodiments.

According to the present embodiments, there may be provided a steer-by-wire steering device 100 comprising a steering shaft 102 including a wing portion 110 radially extruding from an outer circumferential surface thereof, a housing 120 having a receiving space 121 for receiving the wing portion 110, coupled to the steering shaft 102, and having a rheological fluid 130 in the receiving space 121, and an electronic control unit 160 controlling a viscosity of the rheological fluid 130 to, if the steering angle of the steering shaft 102 reaches a first rotational angle, solidify the rheological fluid 130 to restrain rotation of the steering shaft 120.

Referring to FIG. 1, the wing portion 110 radially protrudes from the outer circumferential surface of the steering shaft 102, and two opposite sides thereof in the circumferential direction are formed to be broad.

Although the drawings illustrate an embodiment in which the wing portion 110 has a substantially rectangular shape provided on two opposite sides in the upper and lower directions, the wing portion 110 may have a different shape or more wing portions 110 may be provided. The wing portion 110 suffices as long as it has a shape that may cause resistance by the rheological fluid 130 during rotation.

The housing 120 has the receiving space 121 in which the rheological fluid 130 is provided and receives the wing portion 110 in the receiving space 121. The housing 120 is coupled to the steering shaft 102.

Although not shown in the drawings, a bearing may be provided at the coupling portion of the housing 120 and the steering shaft 102 to support rotation of the steering shaft 102, and a seal may be installed to prevent leakage of the rheological fluid 130.

If the steering angle to the left or right reaches the first rotational angle, the electronic control unit 160 may solidify the rheological fluid 130, restraining rotation of the steering shaft 102 and preventing the driver from further rotating the steering wheel 101.

In other words, as the steering shaft 102 is rotated according to the driver's manipulation of the steering wheel 101, the wing portion 110 is rotated in the receiving space 121. If the steering angle reaches the first rotational angle, the electronic control unit 160 solidifies the rheological fluid 130 in the receiving space 121, restraining rotation of the wing portion 110 and the steering shaft 102 to disable the driver from rotating the steering wheel 101.

The rheological fluid 130 may be an electro-rheological fluid or a magneto-rheological fluid. The electro-rheological fluid is a material that is increased in viscosity and solidified if an electric field is applied thereto, and the magneto-rheological fluid is a material that is increased in viscosity and solidified if a magnetic field is applied thereto.

Referring to FIG. 2, in a state in which no electric field or magnetic field is applied to the electro-rheological fluid or magneto-rheological fluid, the particles may freely be moved, so that the electro-rheological fluid or magneto-rheological fluid exhibits the characteristics of a liquid. If an electric field or magnetic field is applied to the electro-rheological fluid or magneto-rheological fluid, the particles are aligned, and viscosity is increased, and if the strength of the applied electric field or magnetic field increases, the electro-rheological fluid or magneto-rheological fluid may exhibit the characteristics of a solid.

Referring back to FIG. 1, the rheological fluid 130 is an electro-rheological fluid, and the housing 120 may have an electric field application unit 140 connected with the electronic control unit 160 to apply an electric field to the electro-rheological fluid.

The electric field application unit 140 may include, e.g., conductors facing each other with the electro-rheological fluid disposed therebetween and, as the electronic control unit 160 generates a voltage difference between the conductors, the electric field application unit 140 may apply an electric field to the electro-rheological fluid.

Alternatively, the rheological fluid 130 may be a magneto-rheological fluid and the housing 120 may have a magnetic field application unit 150 connected with the electronic control unit 160 to apply a magnetic field to the magneto-rheological fluid.

The magnetic field application unit 150 may include a coil surrounding, e.g., the magneto-rheological fluid and, as the electronic control unit 160 applies to a current to the coil, the magnetic field application unit 150 may apply a magnetic field to the magneto-rheological fluid.

Referring to FIG. 3, if the steering angle reaches the first rotational angle, the electronic control unit 160 may increase the viscosity of the rheological fluid 130 to a threshold viscosity value to thereby solidify the rheological fluid 130, restraining the driver's manipulation of the steering wheel 101.

In other words, if the steering angle at which the driver rotates the steering wheel 101 to the left or right reaches the first rotational angle, the rheological fluid 130 may be solidified, and manipulation of the steering wheel 101 may be restrained. As the first rotational angle is arbitrarily set, the maximum rotational angle of the steering wheel may easily be changed.

The conventional steer-by-wire steering device limits the maximum rotational angle of the steering wheel 101 using a nut which is axially slid by rotation of the steering shaft and stoppers on two opposite sides of the nut. In such a structure, each component needs to be manufactured in a different dimension to set a different maximum rotational angle per vehicle type or the interval between the stoppers needs be varied and, after assembly, it is hard to change the maximum rotational angle.

However, according to the present embodiments, it is possible to easily set the maximum rotational angle to differ even only by changing the first rotational angle. Thus, it is possible to set a different maximum rotational angle per vehicle type with the same component and to change the maximum rotational angle even after assembly.

The first rotational angle may be set to differ depending on the driver's preference or be changed in real-time depending on, e.g., weather or road conditions.

Further, in the conventional steer-by-wire steering device, when the maximum rotational angle is reached, the nut may hit the screw, causing noise and resultantly degrading the driver's steering feeling. Further, the coupling portion of the stopper may be damaged. As such, durability may be reduced.

However, according to the present embodiments, the rheological fluid 130 is solidified at the first rotational angle to limit the steering angle. Thus, no collision is caused, so that noise may be mitigated. Further, the driver's steering feeling and durability may be enhanced.

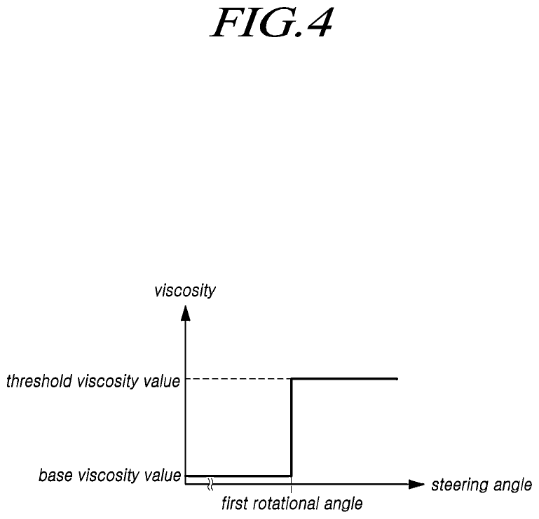

Referring to FIG. 4, the electronic control unit 160 may set the viscosity of the rheological fluid 130 to a base viscosity value when the steering angle is smaller than the first rotational angle.

The base viscosity value is smaller than the threshold viscosity value. As the electronic control unit 160 applies a low strength of electric field or magnetic field to the rheological fluid 130 to set the viscosity of the rheological fluid 130 to the base viscosity value, the resistance to the wing portion 110 when the steering shaft 102 is rotated may be increased, so that the driver's manipulation of the steering wheel 101 is heavy and steering feeling may be enhanced.

In other words, in the steer-by-wire steering device, as generally known, a reaction force motor is connected to the steering shaft to generate reaction torque to increase the driver's steering feeling. It is possible to assist the output of the reaction force motor by setting the viscosity of the rheological fluid 130 to the base viscosity value in a state in which the steering angle is smaller than the first rotational angle.

Even when no electric field or magnetic field is applied to the rheological fluid 130, the rheological fluid 130 has a predetermined viscosity. However, as the electronic control unit 160 applies a predetermined current to the electric field application unit 140 or magnetic field application unit 150 to set the viscosity of the rheological fluid 130 to the base viscosity value, the resistance to the wing portion 110 when the steering shaft 102 is rotated may be increased, thus increasing the steering feeling or assisting the output of the reaction force motor.

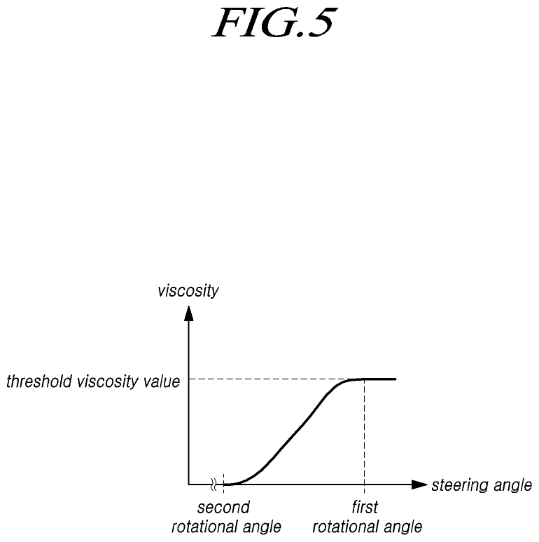

Referring to FIG. 5, when the steering angle has a value between the first rotational angle and a second rotational angle smaller than the first rotational angle, the electronic control unit 160 may increase the viscosity of the rheological fluid 130 as the steering angle increases.

In other words, according to the embodiment shown in FIG. 3, at the moment that the steering angle reaches the first rotational angle, the electronic control unit 160 solidifies the rheological fluid 130. However, as in the embodiment shown in FIG. 5, from the moment that the steering angle reaches the second rotational angle, the electronic control unit 160 applies current to the electric field application unit 140 or magnetic field application unit 150 and, as the steering angle increases, it increases the viscosity of the rheological fluid 130 so that the rheological fluid 130 may be solidified if the steering angle reaches the first rotational angle.

Accordingly, as the driver manipulates the steering wheel 101 so that the steering angle is larger than the second rotational angle, the resistance to the wing portion 110 increases and, if the steering angle reaches the first rotational angle, the rotation of the steering wheel 101 is restrained.

It is possible to more smoothly restrict rotation of the steering wheel 101 at the maximum rotational angle and increase the driver's steering feeling by increasing the viscosity of the rheological fluid 130 gradually as shown in FIG. 5, rather than solidifying the rheological fluid 130 instantaneously as shown in FIG. 3.

Further, it is possible to prevent the steering shaft 102 and the steering wheel 101 from suddenly stopping, enhancing the durability of peripheral components as well as the steering shaft 102.

The difference between the first rotational angle and the second rotational angle may be 10° or more and 20° or less. For example, when the first rotational angle is 360°, the second rotational angle may be 340° or more and 350° or less.

However, the difference not less than 10° and not more than 20° is merely an example and, like being capable of arbitrarily changing the first rotational angle depending on, e.g., the driver's preference, weather or road conditions, the second rotational angle may also be arbitrarily changed so that the difference between the first rotational angle and the second rotational angle may be changed as well.

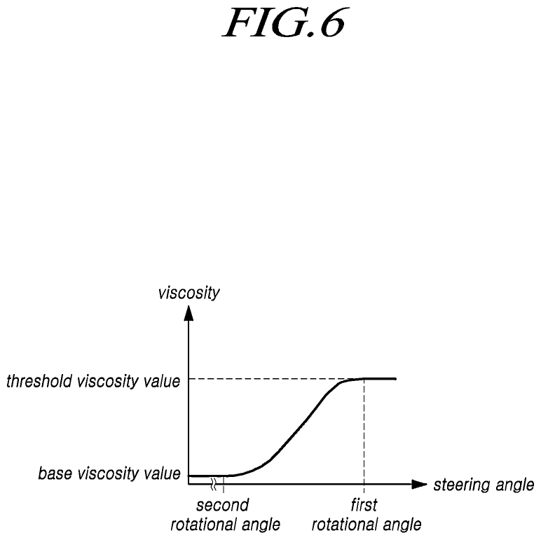

Referring to FIG. 6, similar to what is shown in FIG. 4, when the steering angle is smaller than the second rotational angle, the electronic control unit 160 may set the viscosity of the rheological fluid 130 to the base viscosity value, thereby increasing the driver's steering feeling and assisting the output of the reaction force motor.

Meanwhile, it is possible to set a different maximum rotational angle of the steering wheel 101 by arbitrarily changing the first rotational angle as described above. The maximum rotational angle may be initially set to differ per vehicle type, or may be set to differ depending on the driving mode.

Referring to FIG. 7, the first rotational angle may be determined by the driving mode of the vehicle.

The driving modes of the vehicle may include, e.g., a comfort mode and a sports mode. The driver may arbitrarily set the driving mode of the vehicle. The electronic control unit 160 may set a different maximum rotational angle of the steering wheel 101 by changing the first rotational angle depending on the set driving mode.

As is generally known, the comfort mode is a driving mode more suitable for low-speed driving by lightening the driver's steering feeling on the steering wheel, and the sports mode is a driving mode more suitable for high-speed driving by making the driver's steering feeling on the steering wheel heavier.

The steering angle of the wheel corresponding to the manipulation of the steering wheel 101 is set to be relatively large in the comfort mode and relatively small in the sports mode. Thus, it is possible to further facilitate the driver's manipulation of the steering wheel 101 by setting the maximum rotational angle of the steering wheel 101 to be larger in the comfort mode and to be smaller in the sports mode.

In other words, the first rotational angle may be set to a first value when the driving mode is the comfort mode and to be a second value smaller than the first value when the driving mode is the sports mode.

The electronic control unit 160 receives the initial setting of the driving mode or the driving mode set by the driver to determine the driving mode (S100) and, if the driving mode is the comfort mode, sets the first rotational angle to the first value (S200) and, if the driving mode is the sports mode, sets the first rotational angle to the second value smaller than the first value (S300).

For example, the first value may be set to 450° so that in the comfort mode, the steering wheel 101 may be rotated 900° in total, and the second value may be set to 324° so that in the sports mode, the steering wheel 101 may be rotated 628° in total.

Referring to FIG. 8, the vehicle may have other modes, e.g., normal mode (standard mode) and echo mode, than the comfort mode and the sports mode. In such a case, the first rotational angle may be set to a third value (S400), and the third value may be set to a proper value depending on the purpose of the other modes.

The first rotational angle may have a number of values corresponding to the number of other modes.

As described above, in the conventional steer-by-wire steering device, it is hard to change the maximum rotational angle after assembly. However, according to the present embodiments, it is possible to easily set a different maximum rotational angle depending on the driving mode of the vehicle by changing the first rotational angle.

Further, the first value to the third value may also be set to differ depending on, e.g., the driver's preference, weather, or road conditions.

According to the present embodiments, it is possible to easily set and change the maximum rotational angle of the steering wheel and increase the driver's steering feeling and durability when the steering wheel reaches the maximum rotational angle.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

[symbol]

### CROSS-REFERENCE TO RELATED APPLICATION

This application claims priority to Korean Patent Application No. 10-2020-0005212 filed in the Korean Intellectual Property Office on Jan. 15, 2020, the disclosure of which is incorporated by reference herein in its entirety.

1. A steer-by-wire steering device, comprising:
a steering shaft including a wing portion radially extruding from an outer circumferential surface thereof;
a housing having a receiving space for receiving the wing portion, coupled to the steering shaft, and having a rheological fluid in the receiving space; and
an electronic control unit controlling a viscosity of the rheological fluid based on a steering angle of the steering shaft.

2. The steer-by-wire steering device of claim 1, wherein the rheological fluid is an electro-rheological fluid, and wherein the housing has an electric field application unit connected with the electronic control unit to apply an electric field to the electro-rheological fluid.

3. The steer-by-wire steering device of claim 1, wherein the rheological fluid is a magneto-rheological fluid, and wherein the housing has a magnetic field application unit connected with the electronic control unit to apply a magnetic field to the magneto-rheological fluid.

4. The steer-by-wire steering device of claim 1, wherein the electronic control unit increases the viscosity of the rheological fluid to restrain the rotation of the steering shaft if the steering angle of the steering shaft reaches a first rotational angle.

5. The steer-by-wire steering device of claim 4, wherein the electronic control unit solidifies the rheological fluid to restrain the rotation of the steering shaft.

6. The steer-by-wire steering device of claim 4, wherein the electronic control unit sets the viscosity of the rheological fluid to a base viscosity value if the steering angle is smaller than the first rotational angle.

7. The steer-by-wire steering device of claim 4, wherein the electronic control unit increases the viscosity of the rheological fluid as the steering angle increases if the steering angle has a value between the first rotational angle and a second rotational angle smaller than the first rotational angle.

8. The steer-by-wire steering device of claim 7, wherein a difference between the first rotational angle and the second rotational angle is 10° or more and 20° or less.

9. The steer-by-wire steering device of claim 7, wherein the electronic control unit sets the viscosity of the rheological fluid to a base viscosity value if the steering angle is smaller than the second rotational angle.

10. The steer-by-wire steering device of claim 4, wherein the first rotational angle is determined by a driving mode of a vehicle.

11. The steer-by-wire steering device of claim 10, wherein the first rotational angle is set to a first value if the driving mode is a comfort mode and is set to a second value smaller than the first value if the driving mode is a sports mode.

12. The steer-by-wire steering device of claim 11, wherein the first value is 450°.

13. The steer-by-wire steering device of claim 11, wherein the second value is 324°.
